(19) United States
(12) Patent Application Publication
(10) Pub. No.: US 2007/0106836 A1
(43) Pub. Date: May 10, 2007

(54) Semiconductor solid state disk controller

(76) Inventors: Jeong-Woo Lee, Seoul (KR); Dong-Ryul Ryu, Hwaeong-gun (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/594,893

(22) Filed: Nov. 9, 2006

(30) Foreign Application Priority Data
Nov. 10, 2005 (KR) 2005-107753

(51) Int. Cl. G06F 12/00

(52) U.S. Cl. 711/103

(57) ABSTRACT

A semiconductor solid state disk control device includes a flash interface configured to interface with the flash memory. The control device also includes a host interface configured to interface with the host. The control device also includes a first clock generator configured to generate a first driving clock to the host interface. The control device also includes a second clock generator configured to generate a second driving clock to the flash interface independent of the first clock generator.

### BACKGROUND OF THE INVENTION

1. Field of the Invention

The present invention relates to an electronic device and, more particularly, to a semiconductor disk controller that controls data transfer between a host and flash memory.

This U.S. non-provisional patent application claims priority under 35 U.S.C. § 119 of Korean Patent Application 2005-107753 filed on Nov. 10, 2005, the entire contents of which are hereby incorporated by reference.

2. Description of the Related Art

Magnetic disks have been traditionally used as data storage devices in many electronic appliances. However, advances in semiconductor technology have lead to an increase in the use of a semiconductor solid state disk (SSD) which uses a flash memory as a storage device, in areas such as computer systems and portable devices. Thus, there seems to be a trend towards the use of a SSD as a storage device instead of a magnetic disk. In spite of having features such as, for example, a small storage capacity and a high price, the SSD has some other features that make it more attractive as a storage device than the conventional hard disk (HDD).

The features that make SSDs preferable as a storage device are, for example, a fast access rate, a high integration density, and stability against an external impact. Furthermore, advances in manufacturing technologies for SSDS are probably going to reduce the production costs of SSDs and also increase the storage capacities of SSDs. These developments are likely to cause SSDs to replace HDDs as the storage device of choice.

When the SSD is used as a storage device in computer systems and portable devices, a control device is generally used to manage data transfer between a host and a flash memory. Conventionally, computer systems have been using an advanced technology attachment (ATA) protocol by IBM Inc. and an interface compatible with the ATA protocol to transfer data to and from a high capacity storage device (e.g., the HDD). It therefore follows that if the computer systems adopt the SSD as the high capacity storage device of choice, they should have an interface capable of transferring data to and from the flash memory in a manner compatible with the ATA protocol. Hereinafter, a device for controlling overall operations related to data transfer to and from the SSD is called a SSD controller.

FIG. 1 is a schematic block diagram showing a conventional SSD controller 10. The SSD controller 10 includes a Central Processor Unit (CPU) 11, an ATA interface 12, a SRAM cache 13, a flash interface 14, a phase locked loop circuit (PLL) 15, and a demultiplier (or divider) 16. Referring to FIG. 1, the conventional SSD controller 10 may read or write data to and from flash memories 20 to 23. These read and write operations of the SSD controller 10 may be carried out under a control of the CPU 11. In particular, the CPU 11 controls the SSD controller 10 in response to commands from a host (not shown). That is, the CPU 11 receives commands from the host and then determines, based on the commands received, whether data from the host should be stored in a flash memory or data in the flash memory should be read out (i.e., transferred to the host).

The ATA interface 12 exchanges data with the host under a control of the CPU 11. Specifically, the ATA interface 12 fetches the commands and addresses from the host and sends them to the CPU 11. Furthermore, data moving to and from the host via the ATA interface 12 is transferred through the SRAM cache 13 instead of a CPU bus under a control of the CPU 11.

The SRAM cache 13 temporarily stores the data to be transferred to the host or the flash memories 20 to 23. In addition, the SRAM cache 13 is also used to store programs to be executed by the CPU 11. To this end, the SRAM cache 13 may be a buffer memory or any other kind of memory. The flash interface 14 exchanges data with flash memories 20 to 23. The flash interface 14 may be configured to interact with different types of flash memory. For example, the flash interface 14 may be configured to interact with NAND flash memory, a One-NAND flash memory, a multi-level flash memory, etc.

The flash interface 14 is generally configured to operate based on a clocking system. In such an instance, the SSD controller 10 includes a device that provides a clock to the flash interface 14. As shown in FIG. 1, the SSD controller 10 includes a phase locked loop circuit 15 that provides a driving clock of frequency f1 to the flash interface 14. Based on this driving clock frequency f1, the flash interface 14 generates a write enable signal WE and a read enable signal RE in read and write operations of the flash memory 20 to 23. For example, the flash interface 14 demultiplies (or divides) the driving clock of frequency f1 and generates the write enable signal nWE and the read enable signal nRE.

The phase locked loop circuit 15 is a clock generator which provides a driving clock to components of the SSD controller 10. Generally, the phase looked loop circuit 15 generates a clock having a frequency based on the data transfer protocol of the host (i.e., the ATA protocol). This clock of frequency f1 generated from the phase looked loop circuit 15 is supplied to the ATA interface 12, the SRAM cache 13, the flash interface 14, the demultiplier 16, and the CPU 11. While the phase locked loop circuit 15 generates a clock of frequency f1, the CPU 11 requires a driving clock having a frequency lower than a clock frequency of a data transfer protocol. Therefore, the CPU 11 generally receives a demultiplied driving clock from the demultiplier 16.

The demultiplier 16 is a frequency conversion circuit which provides the driving clock to the CPU 11. The CPU 11 uses the driving clock from the demultiplier 16 to perform logic calculations. In other words, the demultiplier 16 generates a clock frequency fc by demultiplying the clock of frequency f1 that is output from the phase looked loop 15 circuit, and sends the clock with a frequency fc to the CPU 11. The frequency fc is lower than the frequency f1 that is used in the data transfer between the flash interface 14 and the flash memories 20 to 23.

As described above, the conventional SSD controller uses only one clock of frequency f1 generated from the internal phase looked loop. However, this clock frequency can be demultiplied by using a demultiplier. Therefore, the ATA interface 12 and the flash interface 14 can use driving clocks that fall within a demultiplied range of the frequency f1 (i.e., one demultiplied frequency set). This system has various shortcomings. For example, having only one clock generator means that cycle times of the write enable signal nWE and the read enable signal nRE are limited within the demultiply range of the frequency f1 generated by the phase looked loop circuit 15. However, it may be difficult for the SSD system to operate efficiently if the cycle times of the write enable signals nWE and the read enable signal nRE of the flash memory are to be included within the demultiply range of the frequency f1 generated by only one phase looked loop circuit 15. This is because the access times for the SSD controller and the data transfer rates to and from the SSD controller are limited by the number of demultiplied frequencies available.

Accordingly, it may be helpful to generate a suitable frequency in the SSD controller so as to reduce an access time of the SSD controller and also improve a data transfer rate. The present disclosure is directed towards overcoming one or more problems associated with the conventional SSD controller.

### SUMMARY OF THE INVENTION

One aspect of the present disclosure includes a semiconductor solid state disk control device which controls a data transfer between a host and a flash memory. The control device includes a flash interface configured to interface with the flash memory. The control device also includes a host interface configured to interface with the host. The control device also includes a first clock generator configured to generate a first driving clock to the host interface. The control device also includes a second clock generator configured to generate a second driving clock to the flash interface independent of the first clock generator.

Another aspect of the present disclosure includes a semiconductor solid state disk control device. The control device includes a first interface configured to exchange data with an external host. The control device also includes a cache memory configured to store input and output data of the first interface temporarily. The control device also includes a second interface configured to exchange data with a nonvolatile memory. The control device also includes a first-in-first-out buffer connected between the cache memory and the second interface, configured to intermediate a data transfer between devices operating with different frequencies. The control device also includes a first clock generator configured to provide a first driving clock to the first interface and the cache memory. The control device also includes a register configured to store a frequency data of a second driving clock provided to the second interface. The control device also includes a second clock generator configured to provide the second driving clock to the second interface according to the frequency data.

Yet another aspect of the present disclosure includes a semiconductor solid state control device. The control device includes a first interface configured to exchange data with an external host. The control device also includes a cache memory configured to store input and output data of the first interface. The control device also includes a second interface configured to exchange data with a nonvolatile memory. The control device also includes a first clock generator configured to provide a first driving clock to the first interface and the cache memory. The control device also includes a first-in-first-out buffer connected between the first interface and the second interface, configured to intermediate a data transfer between devices operating with different frequencies, wherein the second interface receives an external second driving clock in a frequency demultiply range different from a frequency demultiply range of the first driving clock.

Yet another aspect of the present disclosure includes a method of providing a clock signal of a semiconductor solid state disk control device configured to control a data transfer between an external host and a flash memory. The method includes generating a first driving clock to exchange data with the external host. The method also includes generating a second driving clock whose frequency is different from a frequency of the first driving clock, to exchange data with the flash memory.

### BRIEF DESCRIPTION OF THE DRAWINGS

The accompanying drawings are included to provide a further understanding of the invention, and are incorporated in and constitute a part of this specification. The drawings illustrate exemplary embodiments of the present invention and, together with the description, serve to explain principles of the present invention. In the drawings:

FIG. 1 is a block diagram illustrating a conventional semiconductor solid state disk controller;

FIG. 2 is a block diagram illustrating a semiconductor solid state disk controller in accordance with an exemplary disclosed embodiment;

FIG. 3 is a block diagram illustrating a semiconductor solid state disk controller in accordance with an alternative exemplary disclosed embodiment; and

FIGS. 4(A) and 4(B) are timing diagrams showing read and write operations of an SSD controller.

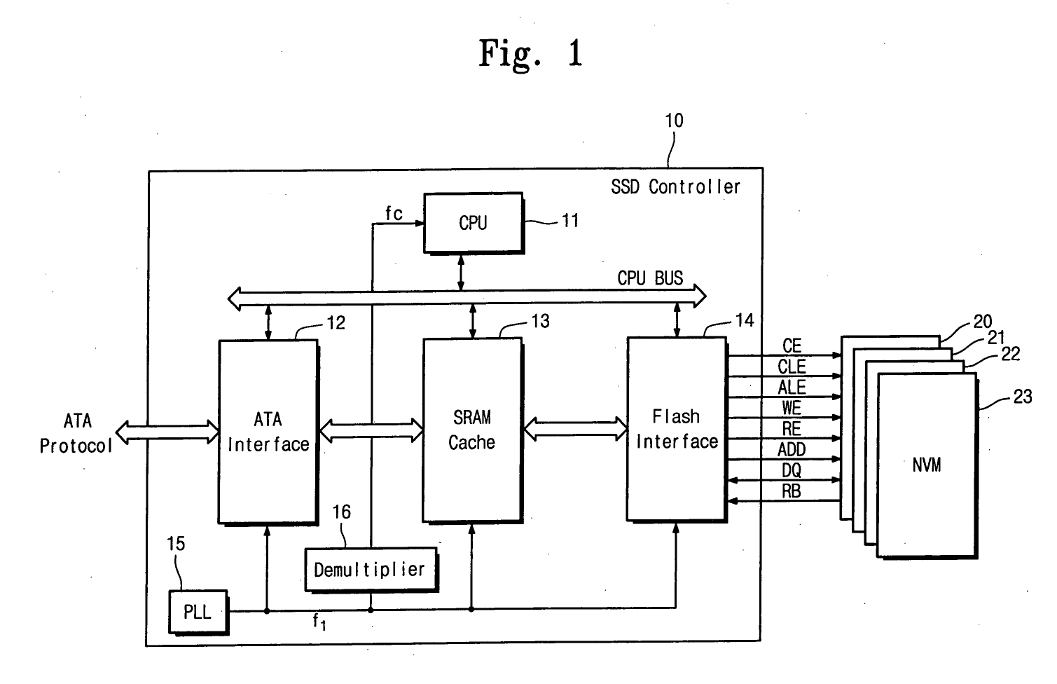

### DETAILED DESCRIPTION OF EXEMPLARY EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the invention to those skilled in the art. Like numerals refer to like elements throughout the specification.

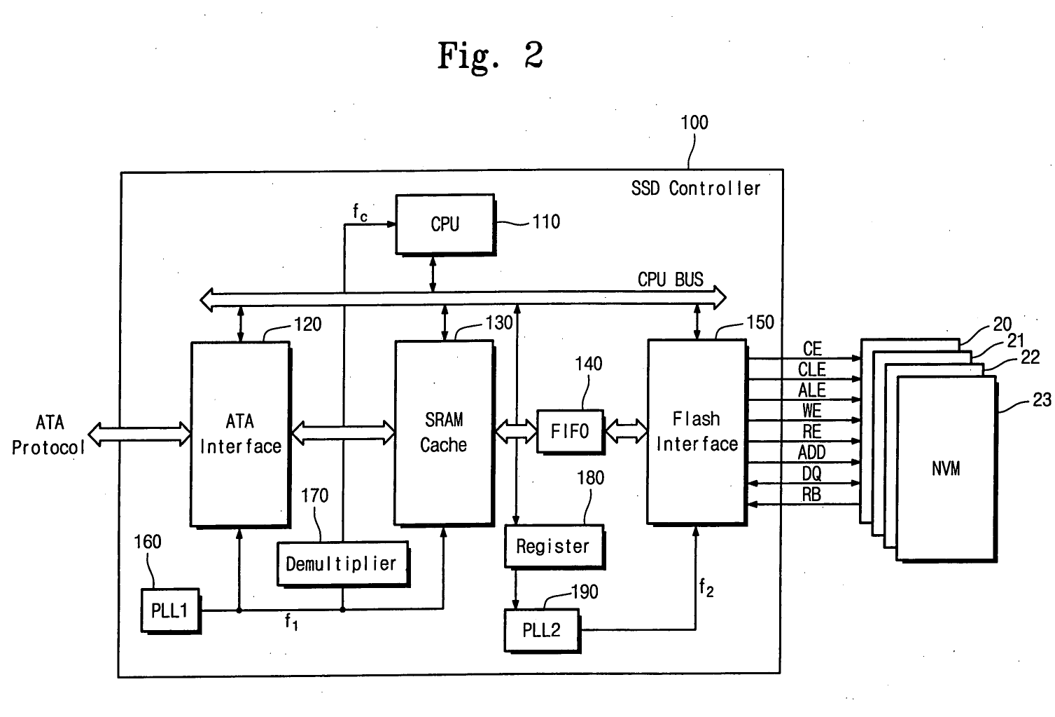

FIG. 2 is a block diagram illustrating a semiconductor solid state disk (SSD) controller 100 in accordance with an exemplary disclosed embodiment. The SSD controller 100 includes a central processing unit (CPU) 110, an ATA interface 120, a SRAM cache 130, a first-in-first-out buffer (FIFO). 140, a flash interface 150, a first phase locked loop generator (PLL1) 160, a demultiplier 170, a register 180, and a second phase locked loop generator (PLL2) 190. The PLL2 190 in the SSD controller 100 is an additional clock generator configured to provide a driving clock for the flash interface 150 so as to optimize a data transfer rate to and from flash memories 20 to 23.

In an exemplary embodiment, the CPU 110 receives operation commands and addresses from an external host to control the data transfer to and from the SSD controller 100. Specifically, the external operation commands and the addresses are sent to the CPU 110 via the ATA interface 120 and a CPU bus. Furthermore, the CPU 110 sends the operation commands and the addresses to a flash interface 150 to access the flash memories 20 to 23.

The CPU 110 may send control signals via the CPU bus. However, it is well known to those skilled in the art that a control path of the CPU 110 need not be limited to the CPU bus. In addition, the CPU 110 determines the types of the flash memories 20 to 23 installed in the SSD controller 100 by reading a device ID (i.e., by performing a read ID operation) while the SSD controller 100 is booted. That is, the CPU 110 can detect the type of a device in the read ID operation. Based on the type of flash memory detected during the read ID operation, the CPU 110 writes data in the register 180 for setting an optimized driving frequency of the flash memory 20 to 23. The operation of register 180 will be explained later in more detail.

The ATA interface 120 exchanges data with the host under a control of the CPU 110. Specifically, the ATA interface 120 fetches commands and addresses from the host and sends them to the CPU 110 via the CPU bus. Furthermore, the ATA interface 120 may include an additional internal register for latching the sent commands and addresses from the host.

The SRAM cache 130 is configured as a buffer memory for temporarily storing data transferred between the host and the flash memories 20 to 23. Specifically, the flash memories 20 to 23 have relatively slow speeds of read and write operations. To this end, the SRAM cache 130, which can operate at higher speeds, is used as a buffer for a fast data transfer between the flash memories 20 to 23 and the host. A storage capacity of the SRAM cache 130 can be determined according to the type of the flash memories 20 to 23.

In addition to storing data to be transferred between the flash memories 20-23, the SRAM cache 130 may also be used for storing programs to be executed by the CPU 110. In an exemplary embodiment, as shown in FIG. 2, data input or output though the ATA interface 120 from the host is transferred to the flash memories 20 to 23 not by way of the CPU bus but by way of the SRAM cache 130 that is controlled by the CPU 110.

The FIFO 140 is configured to intermediate a data transfer rate between devices driving by different clock frequencies. In an exemplary embodiment, the FIFO 140 is connected between the SRAM cache 130 and the flash interface 150. This is because the flash interface 150 is relatively slower than the SRAM cache 130 as far as data input/output rates are concerned. In order to intermediate a data transfer rate between the two devices having different transfer speeds, the FIFO 140 is inserted between them to be a queue in a data transfer operation. That is to say, the FIFO buffer 140 forms a data transfer path between the SRAM cache 130 and the flash interface 150.

The flash interface 150 sends command and addresses from the CPU 110 to the flash memories 20 to 23. As shown in FIG. 2, the flash interface 150 writes data in the flash memories 20 to 23 or reads out data from the flash memories 20 to 23 using control signals CE, CLE, ALE, WE, RE, etc. In particular, the flash interface 150 receives a clock of frequency f2 to set optimized cycle times tWC and tRC of the write and read enable signals nWE and nRE. Furthermore, the flash interface 150 outputs the write enable signal nWE and the read enable signal nRE to the flash memories 20 to 23 so as to transfer data in a rate corresponding to the rate at which signals nWE and nRE operate.

In an exemplary embodiment, the PLL1 160 is a clock generator which outputs a clock signal of a frequency f1 according to the ATA protocol. As is well known to one skilled in the art, the ATA protocol is an external data transfer standard. Specifically, the clock signal of frequency f1 is generated from the first PLL1 160 to all devices included in the SSD controller 100 except for the flash interface 150.

The demultiplier 170 provides a driving signal to the CPU 110. The driving signal provided by the demultiplier 170 to the CPU 110 has a different frequency than that of the signal used by the other devices in the SSD controller 100 such as the ATA interface 120 and the SRAM cache 130. Generally, a frequency fc of the driving clock used in the CPU 110 is lower than the frequency f1 of the clock used for the data transfer operations. In an exemplary embodiment, the frequency fc is generated by demultiplying the frequency f1. For example, if an ATA66 standard is use as a protocol for an external data transfer, the first PLL1 160 generates a clock signal of 66 MHz. Furthermore, the demultiplier 170 receives the clock signal of 66 MHz and generates a clock signal of 33 MHz (=f1/2) that is provided to the CPU as the driving clock.

The register 180 may store information associated with the frequency of the clock signal output from a second PLL2 190. This stored information used for generating a specific frequency is generally called “locking data”. The locking data of the register 180 defines an output frequency of the second PLL 190. In particular, a default value of the locking data may be set in the register 180 to make the second PLL generate the frequency f1. However, the value of the locking data may be beneficially optimized to generate the frequency f2. This optimization may occur by using information from various sources. For example, the information may be obtained from an external command or control signal, or from a component internal to the SSD controller 100 such as, for example, the CPU 110.

There may be many instances where a default value of the locking data may be unsuitable. Under these circumstances, the second PLL2 190 is configured to operate using locking data that has a non-default value. For example, when a frequency of the clock used in the flash interface 150 is not included in a demultiply range of the frequency f1 (i.e., the default) as a result of a read ID, the CPU 110 loads the locking data for generating the optimized frequency f2 on the register 180. On the other hand, in a data transfer operation of the flash interface 150, the locking data for generating the optimized frequency may be stored in another nonvolatile memory or another register. In addition, the locking data for the optimized frequency may be included in a firmware driving the CPU 110. In this case, the optimized frequency varies according to the types of the flash memories 20 to 23 that interact with the SSD controller 100. That is, the CPU 110 may read IDs of the flash memories 20 to 23 in a booting operation and then load the locking data for the optimized frequency suitable for the ID on the register 180 or another nonvolatile memory.

The second PLL2 190 receives the locking data for the optimized frequency and generates a clock signal having a demultiply range different from that of the clock signal generated from the first PLL1 160. For example, if the frequency f1 outputted from the first PLL 160 is 66 MHz, the demultiply range thereof is a combination of frequencies generated by demultiplying the frequency f1 with an integer. Thus, the demultiply range of the frequency f1 in this example includes 33 MHz, 16.5 MHz, 8.25 MHz, etc. However, when the optimized frequency f2 required for a data does not exist in the demultiply range of the frequency f1, the CPU 110 may store the locking data for the optimized frequency f2 in the register 180. Beneficially, this locking data may be used to make the second PLL2 190 generate a clock signal having an optimized frequency f2 that is required for a data transfer data with the flash memories 20 to 23.

One skilled in the art will appreciate that any other signal generating device may be used in place of the second PLL2 190. For example, an oscillation circuit may be used instead of second PLL2 190. In particular, when an oscillation circuit is used in the SSD controller 100 instead of the second PLL2 190, a different type of data may be stored in the register 180 to help generate a clock having an optimum frequency f2.

Assuming that a second PLL2 190 is used to generate the second clocking signal, the locking data stored in the register 180 generally includes information associated with a denominator of an internal divider (not shown) in the second PLL 190. The denominator of the divider feeds back a frequency output from the second PLL 190 to fix the frequency f2 driving the flash interface 150. As described above, the CPU 110 confirms the optimized locking data by reading the ID of equipped flash memories 20 to 23 (i.e., the read ID). Then, the CPU 110 may load the optimized locking data on the register 180. This loaded optimized locking data is then sent to the second PLL2 190 to generate a driving clock for the flash memory 150. In addition, the CPU 110 may also update the locking data stored in the register 180 in response to external commands and controls.

The second PLL2 190 generates the driving clock with the optimized frequency f2 in response to the locking data output from the register 180. As described above, the driving clock with the optimized frequency f2 is sent to the flash interface 150. Thus, the data transfer can be properly performed between the flash interface 150 and the flash memories 20 to 23.

It should be noted that if the locking data is set to have a default in the register 180, the second PLL2 190 generates the driving clock of the frequency f1 (as in the conventional SSD). However, when the locking data set in the register 180 is changed to the optimized value, the second PLL2 190 beneficially outputs a clock signal with the frequency f2 that may provide an optimum data transfer rate to the flash interface 150. The flash interface 150 receives the optimized driving clock of frequency f2 and generates the write enable signal nWE and a read enable signal nRE to exchange data with the flash memories 20 to 23.

In an exemplary embodiment, the SSD controller 100 includes two driving signals having two different frequencies f1 and f2. The first PLL1 160 outputs the driving clock of frequency f1 to the ATA interface 120 and the SRAM cache 130. The driving clock of frequency f1 is the same as the frequency of the host. Beneficially, the second PLL2 190 may provide a driving clock of a frequency f2 to the flash interface 150 such that the flash interface 150 can transfer data to and from the flash memories 20 to 23 at an optimum data transfer rate. In addition, a first-in-first-out buffer (FIFO) 140 is inserted between the SRAM cache 130 and the flash interface 150. Specifically, the FIFO 140 intermediates the data transfer between the SRAM cache 130 and the flash interface 150 because of them having different operation frequencies. Because the second PLL2 190 provides a signal having a desired frequency, the cycle times of the signals nWE and nRE provided to the flash memories 20 to 23 are adjusted as desired. Therefore, the flash memories 20 to 23 can operate at a most suitable rate.

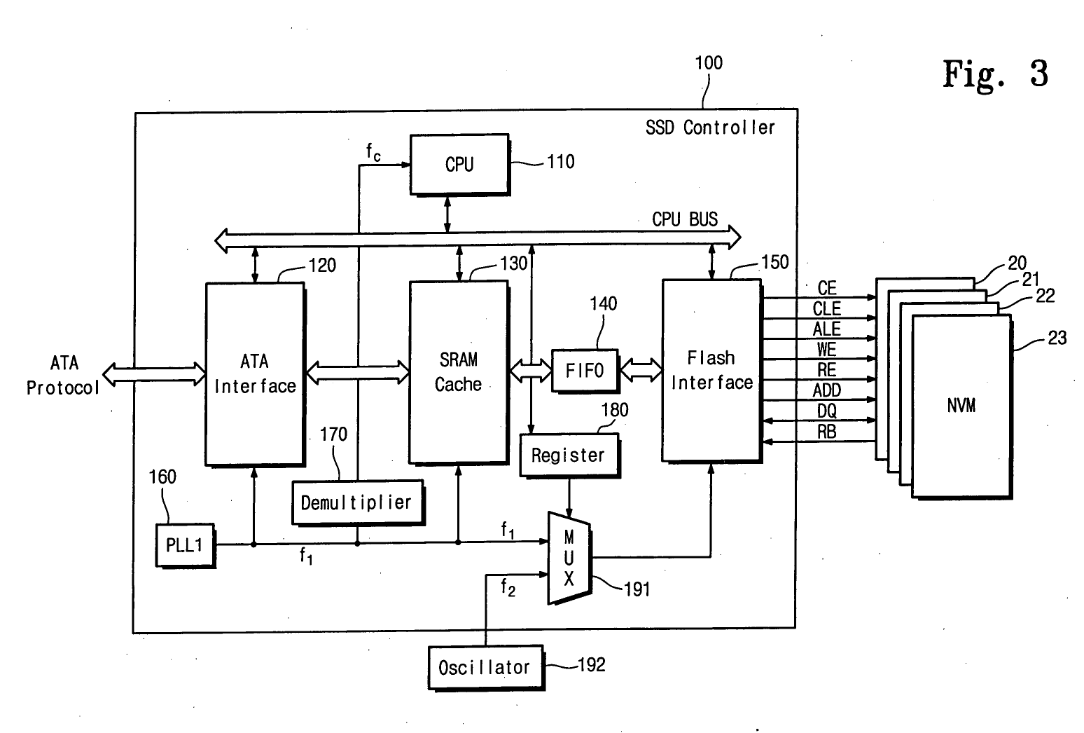

FIG. 3 is a block diagram showing another exemplary embodiment of the present invention. The same reference numbers as in FIG. 2 indicates the same components. Referring to FIG. 3, the SSD controller 100 receives a driving clock for the flash interface 150 from an external oscillator 192. In addition to the register 180, the SSD controller 100 also includes a multiplexer 191. Beneficially, the SSD controller 100 of FIG. 3 changes a default frequency of the driving clock provided to the flash interface into an optimum frequency. In an exemplary embodiment, when the register 180 is set to have a default value (i.e., a default locking data) by the CPU 110, the flash interface 150 receives a driving clock having the same frequency as an output of a first PLL1 160. However, when the register 180 is set to have a locking data for generating the optimum frequency value, the flash interface 150 receives a driving clock having the optimum frequency from the external oscillator 192. That is, the locking data loaded on the register 180 by the CPU 110 determines whether the default frequency f1 or the optimum frequency f2 is provided to the flash interface 150.

The multiplexer 191 may be used to provide signals generated by the first PLL1 160 and the oscillator 192 to the flash interface 150. Specifically, the multiplexer 191 supplies the frequency f1 generated from the first PLL1 160 or the externally provided optimum frequency f2 to the flash interface 150 according to the locking data loaded on the register 180.

The oscillator 192 is an external clock generator and, beneficially, generates a clock signal having the optimum frequency used in a data transfer to and from the flash memories 20 to 23 that interact with the SSD controller 100.

In another exemplary embodiment, the SSD controller 100 may not include an additional clock signal generator. In such an embodiment, the locking data needed to generate a desired frequency may be pre-loaded by CPU 110 on the register 180. Based on the locking data stored in the register 180, the flash interface 150 may receive one of the default clock frequency f1 and the optimized clock frequency f2.

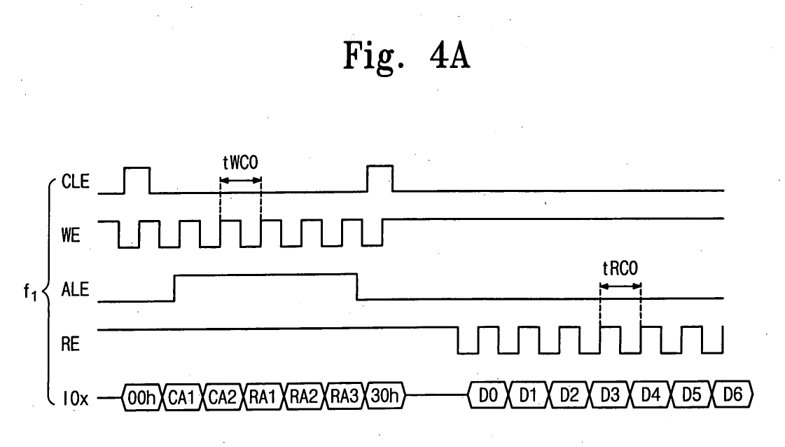

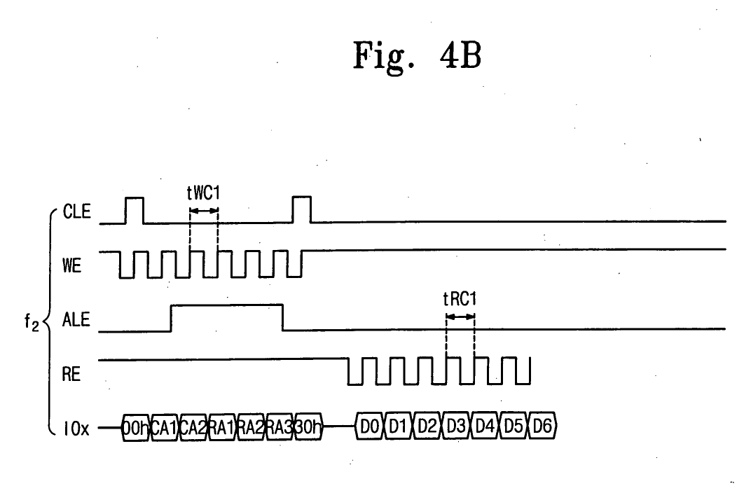

FIGS. 4(A) and 4(B) are timing diagrams showing read and write operations of the SSD controller 100, running in an optimum data transfer rate. Specifically, FIG. 4(A) shows the read and write operations using a clock signal of frequency f1 as a driving clock of the flash interface 150. On the other hand, FIG. 4(B) shows the read and write operations using a clock signal of frequency f2 as a driving clock of the flash interface 150. Hereinafter, the read and write operations of the SSD controller 100 will be fully explained with reference to the FIG. 4.

When a host sends commands and addresses through an ATA interface 120, a CPU 110 receives the commands and the addresses and provides the received operation commands and addresses to the flash interface 150. The flash interface 150 generates a write command 00h and addresses CA1 to RA 3 to the flash memories 20 to 23. Furthermore, the flash interface 150 generates a read command 30h to the flash memories 20 to 23. In addition, the data D0˜D6 in a cell array of the flesh memories 20 to 23 corresponding to the addresses CA1 to RA2 are generated.

When the driving clock having the same frequency f1 as the clock used in the host is provided to the flash interface 150 (in FIG. 4(A)), the read and write operation rates may not be optimized. Because a write cycle time tWCO and a read cycle time tRCO depend on the frequency f1, it is difficult for the flash interface 150 to adjust the cycle time tWCO and the read cycle time independently. That is, if the flash interface 150 selects the most preferable frequency from a range of frequencies generated by demultiplying the frequency f1, the selected frequency may differ from the optimum frequency of operation of the flash memories 20 to 23.

However, as described above, in an exemplary embodiment, the SSD controller 100 includes the second PLL2 190 to generate the clock signal of frequency f2 and the register 180 to control the clock signal, independently. FIG. 4B is a timing diagram illustrating the operation of the SSD controller 100 according to an exemplary disclosed embodiment. Because of the use of the second PLL2 190 and the register 180 to generate an adjustable frequency f2, the write cycle time tWC1 and the read cycle time tRC1 of the flash memories 20 to 23 can be controlled as required. For example, in a test run, the optimum write and read cycle times tWC and tRC, respectively, are determined. Furthermore, beneficially, a locking data for generating the optimum frequency f2 based on the optimum cycle times tWC and tRC is written in the register 180. Then, the internal second PLL2 190 or the external oscillator 200 of the SSD controller 100 generates the driving clock with the optimum frequency f2 according to the locking data. Therefore, the read and write times can be reduced as shown in FIG. 4(B).

The above-described SSD controller can be used in various memory systems. As explained above, the SSD controller 100 includes independently controllable internal or external clock generators 190 and 200. Furthermore, the adjustable clocks provided to the flash interface 150 may help improve a data transfer rate of the flash memories 20 to 23. Therefore these clock generators can be used by the SSD controller 100 to reduce an access time of the SSD controller, which is determined by the data transfer rate.

Although the present invention has been described in connection with exemplary embodiments illustrated in the accompanying drawings, it is not limited thereto. It will be apparent to those skilled in the art that various substitutions, modifications and changes may be thereto without departing from the scope and spirit of the invention.

What is claimed is:

1. A semiconductor solid state disk control device which controls a data transfer between a host and a flash memory, comprising:
a flash interface configured to interface with the flash memory;
a host interface configured to interface with the host;
a first clock generator configured to generate a first driving clock to the host interface; and
a second clock generator configured to generate a second driving clock to the flash interface independent of the first clock generator.

2. The device of claim 1, wherein the second driving clock does not include clock signals in a frequency demultiply range of the first driving clock.

3. The device of claim 2, wherein the clock signals in the frequency demultiply range of the first driving clock have frequencies generated by dividing a frequency of the first driving clock with an integer.

4. The device of claim 2, wherein the second driving clock has a frequency most suitable for a data transfer rate between the flash interface and the flash memory.

5. The device of claim 2, further comprising a first-in-first-out buffer connected to an input terminal of the flash interface to intermediate a data transfer between devices operating with different frequencies.

6. The device of claim 1, wherein the first and second clock generators are phase locked loop circuits.

7. The device of claim 1, wherein the second clock generator is located external to the SSD controller.

8. The device of claim 1, further comprising a register configured to load frequency data which sets a frequency generated from the second clock generator.

9. The device of claim 8, wherein the frequency data is a locking data which sets a frequency generated from the second clock generator.

10. The device of claim 9, wherein if the locking data has a default value, the second clock generator outputs the first driving clock and if the locking data has an optimum value, the second clock generator outputs the second driving clock.

11. A semiconductor solid state disk control device, comprising:
a first interface configured to exchange data with an external host;
a cache memory configured to store input and output data of the first interface temporarily;
a second interface configured to exchange data with a nonvolatile memory;
a first-in-first-out buffer connected between the cache memory and the second interface, configured to intermediate a data transfer between devices operating with different frequencies;
a first clock generator configured to provide a first driving clock to the first interface and the cache memory;
a register configured to store a frequency data of a second driving clock provided to the second interface; and
a second clock generator configured to provide the second driving clock to the second interface according to the frequency data.

12. The device of claim 11, wherein the second driving clock is in a frequency demultiply range different from a frequency demultiply range of the first driving clock.

13. The device of claim 12, wherein clock signals in the frequency demultiply range of the first driving clock have frequencies generated by dividing a frequency of the first driving clock with an integer.

14. The device of claim 12, wherein the second driving clock is most suitable for a data transfer between the flash interface and the nonvolatile memory.

15. The device of claim 11, wherein the second interface generates at least one of a write enable signal and a read enable signal according to the second driving clock in a data transfer with the nonvolatile memory.

16. The device of claim 11, wherein the first and second clock generators are phase locked loop circuits.

17. The device of claim 16, wherein the frequency data is a locking data which sets a frequency output from the second clock generator.

18. The device of claim 17, wherein if the locking data has a default value, the second clock generator outputs the first driving clock and if the locking data has an optimum value, the second clock generator outputs the second driving clock.

19. A semiconductor solid state control device, comprising:
a first interface configured to exchange data with an external host;
a cache memory configured to store input and output data of the first interface;
a second interface configured to exchange data with a nonvolatile memory;
a first clock generator configured to provide a first driving clock to the first interface and the cache memory; and
a first-in-first-out buffer connected between the first interface and the second interface, configured to intermediate a data transfer between devices operating with different frequencies,
wherein the second interface receives an external second driving clock in a frequency demultiply range different from a frequency demultiply range of the first driving clock.

20. The device of claim 19, wherein clock signals in the frequency demultiply range of the first driving clock have frequencies generated by dividing a frequency of the first driving clock with an integer.

21. The device of claim 19, further comprising a multiplexer configured to provide at least one of the first and external second driving clocks to the second interface.

22. The device of claim 21, wherein the multiplexer provides the first driving clock to the second interface in a default mode and the external second driving clock in an optimum mode.

23. The device of claim 23, wherein the second interface generates at least one of a write enable signal and a read enable signal according to an input driving clock in a data transfer with the nonvolatile memory.

24. A method of providing a clock signal of a semiconductor solid state disk control device configured to control a data transfer between an external host and a flash memory, comprising:
generating a first driving clock to exchange data with the external host; and
generating a second driving clock whose frequency is different from a frequency of the first driving clock, to exchange data with the flash memory.

25. The method of claim 24, wherein the frequency of the second driving clock optimizes a data transfer rate of the flash memory.

26. The method of claim 24, wherein the second driving clock is generated in the semiconductor solid state disk.

27. The method of claim 24, wherein the second driving clock is generated in a device external to the semiconductor solid state disk.

28. The method of claim 24, wherein the first and second driving clocks are respectively generated from phase locked loop circuits different from each other.

29. The method of claim 28, wherein the phase locked loop circuit generating the second driving clock comprises a register storing locking data which adjusts the frequency of the second driving clock.

30. The method of claim 29, wherein the register is controlled to store locking data which generates the first driving clock in a default mode and locking data which generates the second driving clock in an optimum mode.
